(19) United States
(12) Patent Application Publication
(10) Pub. No.: US 2005/0123264 A1
(43) Pub. Date: Jun. 9, 2005

(54) Stationary optical attenuator flange

(76) Inventor: Tsunehiro Takahashi, Yamato-shi (JP)

Correspondence Address: MOLEX INCORPORATED, 2222 WELLINGTON COURT, LISLE, IL, 60532, US

(21) Appl. No.: 10/983,771

(22) Filed: Nov. 8, 2004

(30) Foreign Application Priority Data
Nov. 13, 2003 (JP) 2003-383285

(51) Int. Cl. G02B 6/00

(52) U.S. Cl. 385/140

(57) ABSTRACT

A stationary optical attenuator having a ferrule assembly 20 including a capillary 21 having an attenuation fiber 23 fixed along its center axis and a flange 22 having the capillary 21 inserted therein. The flange 22 has one or more slits 221 made in its tubular section 22c. These slits 221 extend longitudinally from one end 22a of the tubular section 22c, and the capillary 21 is fixed to the flange 22 by applying and filling the slits 221 with an adhesive 224.

### FIELD OF THE INVENTION

The present invention relates generally to optical attenuators and, more particularly, to stationary optical attenuators having flanges for adhesively engaging capillaries.

### PRIOR ART

A conventional stationary optical attenuator comprises a ferrule assembly that comprises a capillary having an attenuation fiber fixed along its center axis and a flange enclosing the capillary (see Patent Documents 1 and 2).

The attenuation fiber is coated with a certain material that effectively causes attenuation of the light beam traveling therein. The ferrule assembly is press-fitted in a split sleeve, and the so combined object is fixedly held in an associated plug frame. Then, the integral unit is so placed that it may be aligned with the optical axis of the whole system. Additionally, an inner housing may be integrally connected to the plug frame and the integral combination is accommodated in a plug housing. Usually the capillary is made of a ceramic material such as zirconium, whereas the flange is made of metal such as brass.

Patent Document 1: Japanese Patent Laid-Open No. 2002-258055 (see Paragraphs (0002) to (0009) and FIG. 4; and Paragraphs (0020) to (0024) and FIGS. 1-3)

Patent Document 2: Japanese Patent Laid-Open No. 2002-258104 (see Paragraphs (0002) to (0009) and FIG. 4; and Paragraphs (0021) to (0025) and FIGS. 1-3)

### SUMMARY OF THE INVENTION

In such a conventional stationary optical attenuator, the capillary is press-fitted in and fastened to the flange. Otherwise, the capillary is bonded to the flange while being tentatively held by a jig in position; this is necessitated for aligning the capillary with the flange relative to their optical axis. The press-fitting, however, is apt to scar the outer surface of the capillary. Still disadvantageously, the capillary cannot be correctly positioned relative to the flange with ease. For these and other reasons, optical attenuators cannot be produced with efficiency.

One object of the present invention is to provide a stationary optical attenuator structure, which significantly contributes to efficient production. Another object of the present invention is to provide a flange for such stationary optical attenuator structure.

A stationary optical attenuator comprising: a ferrule assembly comprising a capillary having an attenuation fiber fixed along its center axis and a flange having the capillary press-fitted therein; a plug frame and an inner housing both fixedly holding the ferrule assembly in alignment with their optical axis, is improved according to the present invention in that the flange has slits made in its tubular section, the slits extending longitudinally from one end of the tubular section, and that the capillary is fixed to the flange by applying and filling the slits with adhesive agent.

A stationary optical attenuator, a flange structure, having a capillary press-fitted therein and the capillary having an attenuation fiber fixed along its center axis, is improved according to the present invention in that the flange has slits extending longitudinally from one end, and that the capillary is fixed to the flange by applying and filling the slits with adhesive agent.

In an exemplary stationary optical attenuator, the inner diameter of the flange is somewhat smaller than the outer diameter of the capillary at the one end, with the inner diameter of the flange gradually increasing toward the other end of the tubular section. This permits the capillary to be easily inserted from the other end into the flange without requiring any pushing force.

The slits may extend half the length of the flange. Furthermore, two slits may be included, where the slits are diametrically opposite to each other.

The flange may have a square collar formed at the other end, thereby allowing the ferrule assembly to be fitted in the plug frame at any of the predetermined rotary positions, which are 90 degrees apart from each other. The square collar may have four side planes, one selected side plane having a setting mark made therein.

The tubular section of the flange is longitudinally narrow-cut to provide the flange with resiliency, thereby facilitating insertion of the capillary into the flange without fear of scarring the capillary. The capillary is tentatively set in a first position, and then fastened to the flange by applying and filling the slits with liquid adhesive. The inner housing and plug frame used are separate parts. This contributes to the downsizing of the stationary optical attenuator, and at the same time, permits the selective four-directional orientation of the ferrule assembly relative to the plug frame.

With this arrangement, downsizing of the stationary optical attenuator as well as efficient production can be attained.

### BRIEF DESCRIPTION OF THE DRAWINGS

The present invention will now be described in detail with reference to the accompanying drawings, in which:

FIG. 1 is a perspective view showing how a ferrule assembly according to the present invention is nested within an inner housing;

FIG. 2 is a perspective view of a flange, which is one part of the ferrule assembly;

FIG. 3 is a side view of the flange;

FIG. 4 is an end view of the flange as viewed from the left side in FIG. 3;

FIG. 5 is an end view of the flange as viewed from the right side in FIG. 3;

FIG. 6 is a longitudinal section of the flange taken along the line 6-6 in FIG. 3;

FIG. 7 is a perspective view of the ferrule assembly;

FIG. 8 is a side view of the ferrule assembly;

FIG. 9 is a longitudinal section of the ferrule assembly taken along the line 9-9 in FIG. 8;

FIG. 10 illustrates how the ferrule assembly is provided, particularly how the capillary is inserted in the flange;

FIG. 11 illustrates how the capillary is fastened to the flange;

FIG. 12 illustrates how an attenuation fiber is fixedly inserted into the capillary;

FIG. 13 illustrates the ferrule assembly with the extra fiber lengths cut and removed from the opposite ends of the capillary;

FIG. 14 illustrates that the ferrule assembly is rotated 90 degrees about its optical axis;

FIG. 15 illustrates the ferrule assembly with a setting mark made in a selected side of the square collar:

FIG. 16 is a perspective view, showing how a plug frame is applied to the ferrule assembly-and-inner housing combination;

FIG. 17 is a perspective view, showing how a plug housing is applied to the triple combination of ferrule assembly, plug frame and inner housing;

FIG. 18 is a perspective view of the stationary optical attenuator;

FIG. 19 is a longitudinal section of the stationary optical attenuator; and

FIG. 20 is another longitudinal section of the stationary optical attenuator.

### DESCRIPTION OF THE PREFERRED EMBODIMENT

A stationary optical attenuator according to one preferred embodiment of the present invention is described below with reference to the accompanying drawings.

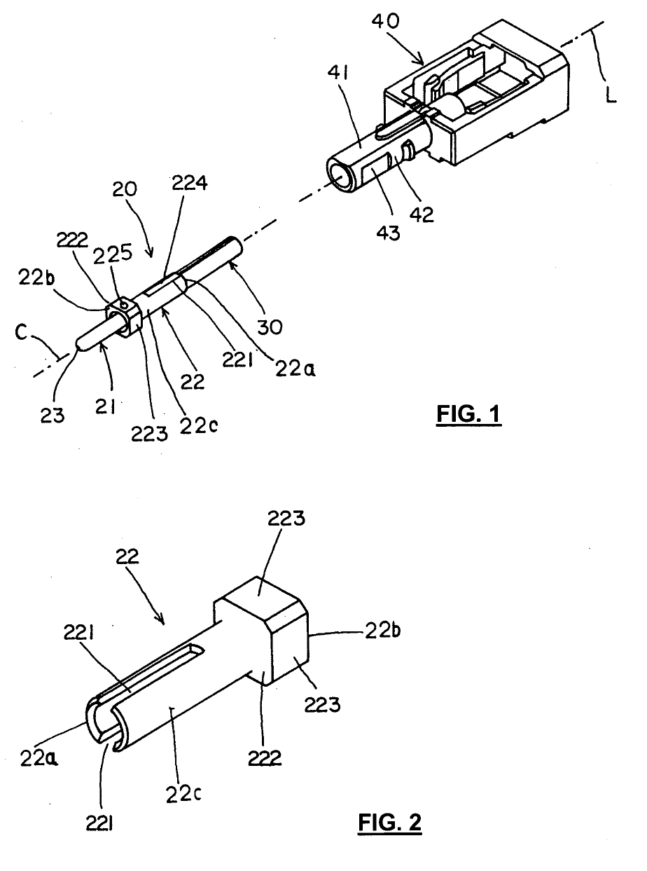

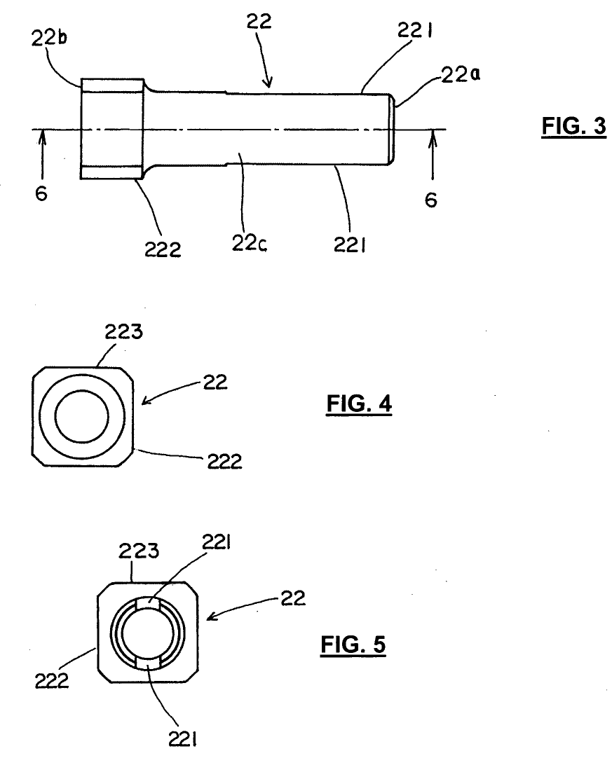

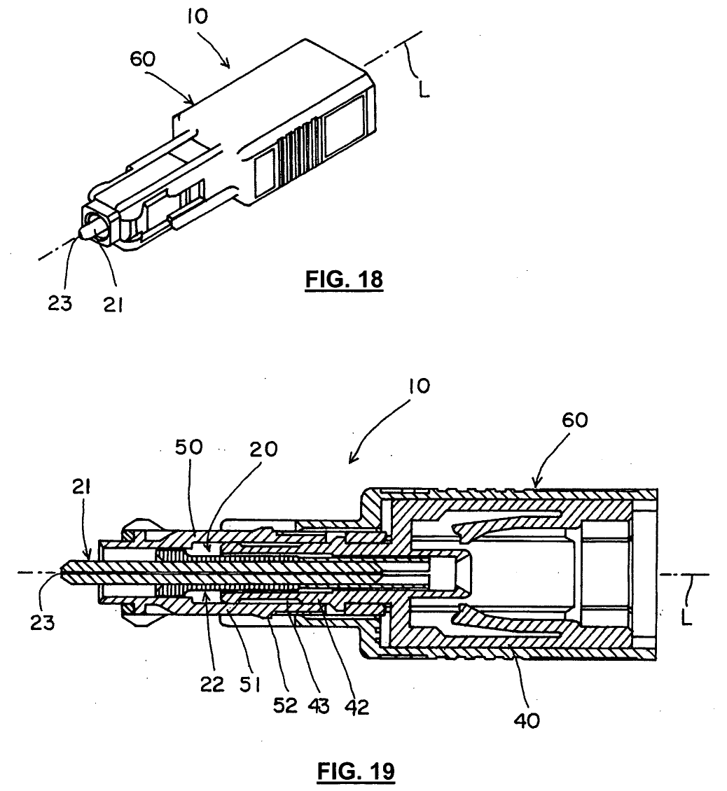

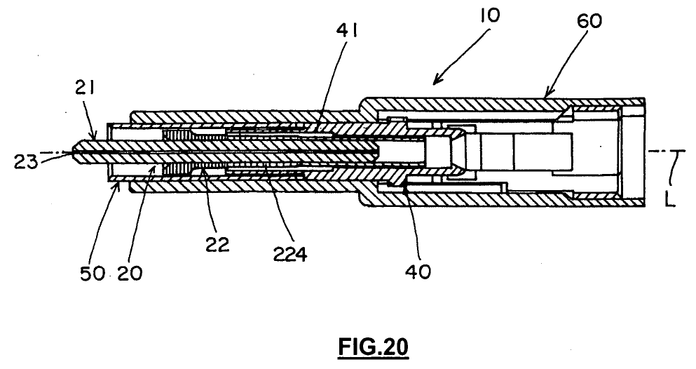

FIG. 1 shows how the ferrule assembly 20 with a slit sleeve 30 applied thereto is nested within the inner housing 40. (see FIGS. 18 to 20) The ferrule assembly 20 includes capillary 21 and a flange 22. The capillary 21 is a cylindrical object of zirconium, which has the attenuation fiber 23 along its center axis. The flange 22 is made of a metal or plastic material, comprising a hollow circular cylindrical or tubular section 22c and a square collar 222 formed on one end, as seen in FIGS. 2 to 6.

The flange 22 is a hollow cylindrical object configured to accommodate the capillary 21 therein. It has one or more narrow long cuts or slits 221 longitudinally extending from the end 22a toward the square collar 222. The slit 221 extends half the length of the flange 22. If formed with two slits, each of the slits 221 is diametrically opposite the other.

The square collar 222 is integrally connected to the other end 22b of the flange 22. The square collar 222 has four side flat surfaces or planes 223.

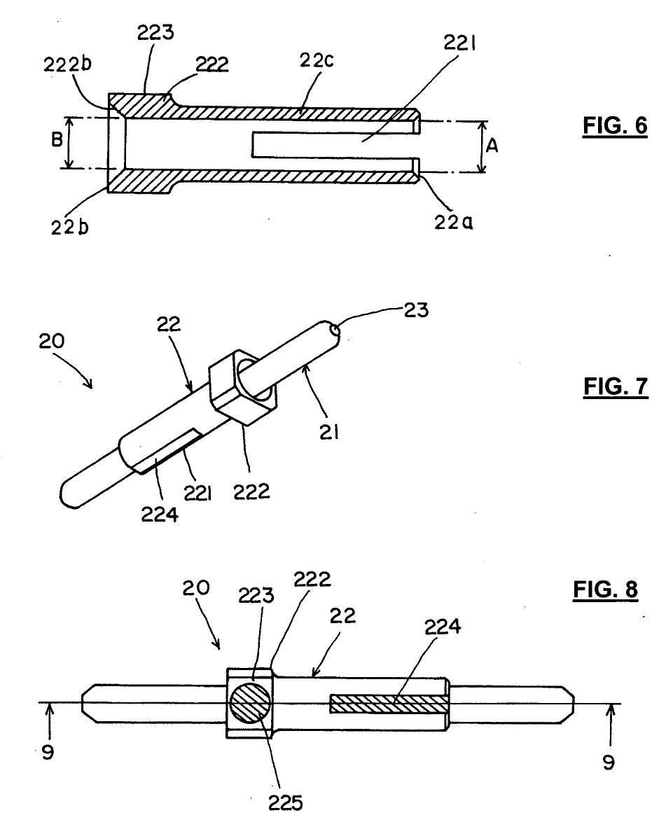

The inner diameter “A” of the flange 22 at the end 22a is somewhat smaller than the outer diameter of the capillary 21, gradually increasing toward the other end 22b (see FIG. 6), thereby permitting the capillary 21 to be easily inserted from the other end 22b into the flange 22 without requiring any pushing force. For example, the diameter “A” is equal to 1.2 mm, whereas the diameter “B” is equal to 1.25 mm. As described above, the flange 22 is longitudinally cut to form plural slits 221, thereby allowing the flange 22 to yieldingly expand in response to insertion of the capillary 21 from the end 22a of the flange 22 while resiliently gripping the capillary 21. Thus, the capillary 21 can be tentatively held in a correct position relative to the flange 22

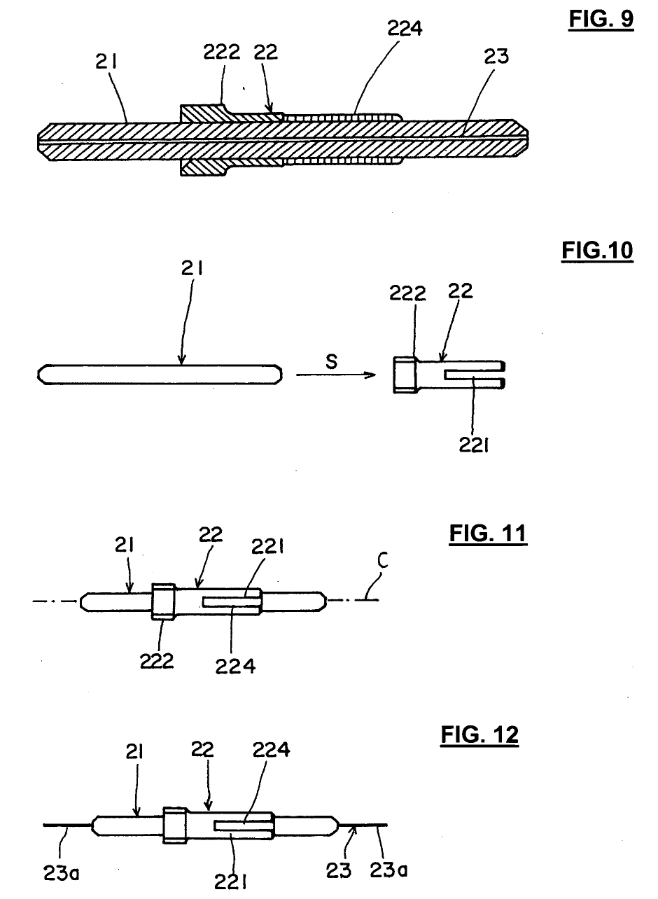

As shown in FIGS. 7 to 9, after tentatively fastening the capillary 21 in the flange 22, the capillary 21 is permanently fixed to the flange 22 by applying and filling the slits 221 with liquid adhesive 224. Because of the resiliency imparted to the flange 22 by the long narrow slits 221, the capillary 21 can be inserted into the flange 22 without applying any push to the capillary 21. When the capillary 21 is put in the correct position, it is bonded to the flange 22 by filling the slits 221 with liquid adhesive. This reduces the danger of rubbing and scarring the surface of the capillary 21. Advantageously, the parts still can be assembled at increased efficiency.

Referring to FIG. 8, a setting mark 225 is made on a selected side 223 of the square collar 222.

FIGS. 10 to 16 show the sequential steps at which the capillary 21 is nested with the flange 22 to provide the ferrule assembly 20, and the setting mark 225 is made in a selected side of the square collar 222. Referring to FIG. 10, the capillary 21 is inserted from the square collar end into the flange 22 until the capillary 21 reaches the correct position in the flange 22. Then, liquid adhesive 224 is applied to the slits 221. The flange 22 is put in an oven with the square collar 222 down so that the liquid adhesive 224 is set. Thanks to the surface tension the liquid adhesive stops at the chamfered circumference 22b (see FIG. 6). Thus, the capillary 21 is fixed to the flange 22 (see FIG. 11).

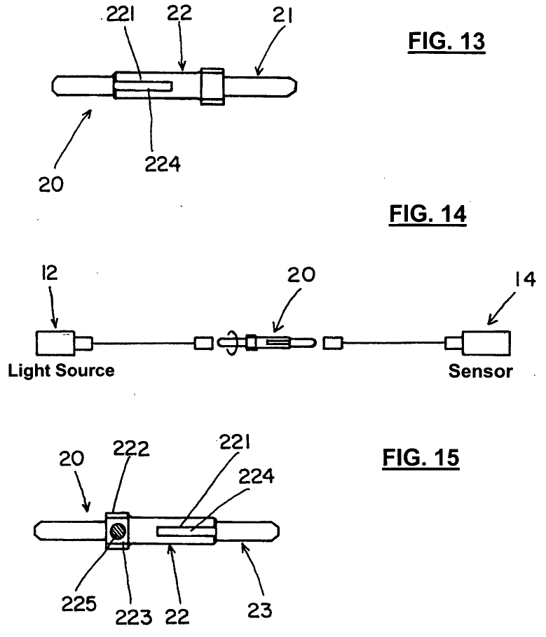

Referring to FIG. 12, an attenuation fiber 23 is longer than the full length of the capillary 21. Liquid adhesive is injected into the very small hole of the capillary 21, and the attenuation fiber 23 is inserted into the capillary 21. When the liquid adhesive is set, the attenuation fiber 23 is fixed to the capillary 21. The extra fiber lengths projecting from the opposite ends of the flange 22 are then cut and removed. The flange 22 is optical-ground on its ends (see FIG. 13).

Referring to FIGS. 14 and 15, the ferrule assembly 20 is oriented in the appropriate angular position relative to the attenuation fiber 23 to cause a required attenuation on the traveling beam of light. Such measurement is performed by using a light source 12 and a photo-sensor 14 (see FIG. 14). These are aligned such that the beam of light from the light source 12 may fall on the photo-sensor 14 after passing through the attenuation fiber 23. The ferrule assembly 20 is then rotated through angular increments of 90 degrees to determine the angular position at which the required attenuation may be caused on the traveling beam of light. A setting mark 225 is made on a selected side 223 of the square collar 222. This assures that the ferrule assembly 20 is correctly arranged and nested within the inner housing 40 by referring to the setting mark 225 so that the required attenuation is caused on the beam of light traveling along the aligned optical axis of the ferrule assembly-and-inner housing combination. The setting mark 225, therefore, can be made on either side of the square collar 222, provided that the selected side of the square collar be fixedly related to a predetermined side of the inner housing 40.

The square shape of the flange's collar 222 permits the incremental ninety-degree rotation of the ferrule assembly 20 to aid in determining the angular position in which the required attenuation is caused. Such incremental control is virtually fine enough to allow all optical attenuators thus calibrated to have their attenuation degrees remaining in the range of allowance.

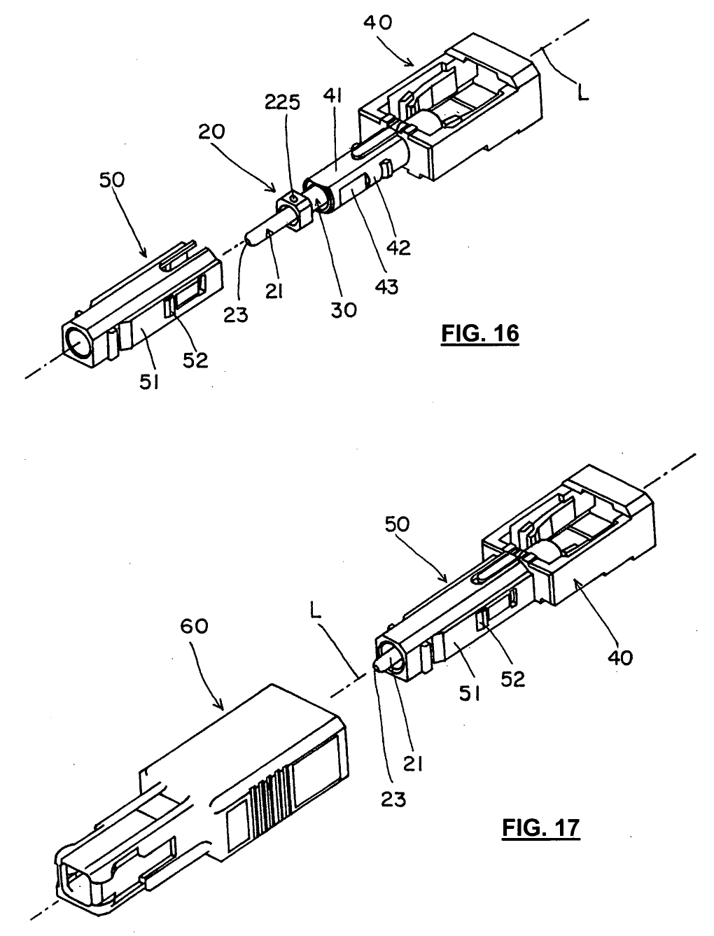

As seen from FIG. 1, the ferrule assembly 20 has its rear capillary exposure inserted into a split sleeve 30. The ferrule assembly-and-split sleeve combination is nested with the inner housing 40 by inserting it into the cylindrical extension 41 of the inner housing 40. Referring to FIG. 16, the cylindrical extension 41 of the inner housing 40 is inserted in a plug frame 50. The ferrule assembly 20 has its optical axis aligned with the optical axis L of the whole assembly.

Referring to FIG. 17, the integral combination of the ferrule assembly 20, the inner housing 40 and the plug frame 50 is put in a plug housing 60, providing a stationary optical attenuator 10 as shown in FIG. 18. The plug housing 60 may be formed of metal, and is strong enough to resist to the bending stress, which might be applied to the plug frame-and-inner housing combination. Thus, it is assured that the connection loss be reduced to possible minimum.

By way of example, the plug housing 60 is made of metal and the inner housing 40 and plug frame 50 are molded of a synthetic resin material. As seen from FIGS. 1 and 19, the cylindrical extension 41 of the inner housing 40 has recesses 43 made on two opposite sides 42, thereby allowing the projections 52 of the overlying plug frame 50 (see FIG. 17) to yieldingly withdraw when the inner housing-and-plug frame combination is inserted into the plug housing 60.

1. A stationary optical attenuator comprising: a ferrule assembly 20 including a capillary 21 having an attenuation fiber 23 fixed along its center axis and a flange 22 having the capillary 21 inserted therein; a plug frame 50 and an inner housing 40 both fixedly holding the ferrule assembly 20 in alignment with their optical axis L, the flange 22 having at least one slit 221 made in its tubular section 22c, the slit 221 extending longitudinally from one end 22a of the tubular section 22c, the capillary 21 being fixed to the flange 22 by applying and filling the slit 221 with an adhesive 224.

2. The stationary optical attenuator according to claim 1 wherein the inner diameter of the flange 22 is somewhat smaller than the outer diameter of the capillary 21 at the one end 22a, the inner diameter of the flange 22 gradually increasing toward the other end 22b of the tubular section 22c, thereby permitting the capillary 21 to be easily inserted from the other end 22b into the flange 22 without requiring any pushing force.

3. The stationary optical attenuator according to claim 1 wherein the slit 221 extends substantially half of the whole length of the flange 22.

4. The stationary optical attenuator according to any of claims 1 to 3, further comprising two slits 221, wherein the slits 221 are diametrically opposite to each other.

5. The stationary optical attenuator according to any of claims 1 to 4 wherein the flange 22 has a square collar 222 formed at the other end 22b, thereby allowing the ferrule assembly 20 to be fitted in the plug frame 50 at any of the predetermined rotary positions, which are 90 degrees apart from each other.

6. The stationary optical attenuator according to claim 5 wherein the square collar 222 has four side flat surfaces 223, which can be selectively used for making a setting mark.

7. The stationary optical attenuator according to claim 1, further comprising a metal plug housing 60 to contain the integral combination of the inner housing 40 and the plug frame 50.

8. A flange structure 22 for a stationary optical attenuator 10, the flange structure 22 having a capillary 21 inserted therein, the capillary 21 having an attenuation fiber 23 fixed along its center axis, the flange structure 22 also having a slit 221 extending longitudinally from one end 22a, the capillary 21 being fixed to the flange 22 by applying and filling the slit 221 with an adhesive 224.

9. A flange structure 22 according to claim 8 wherein the inner diameter of the flange 22 is somewhat smaller than the outer diameter of the capillary 21 at the one end 22a, the inner diameter of the flange 22 gradually increasing toward the other end 22b of the tubular section 22c, thereby permitting the capillary 21 to be easily inserted from the other end 22b into the flange 22 without requiring any pushing force.

10. A flange structure 22 according to claim 8 wherein the slit 221 extends substantially half of the whole length of the flange 22.

11. A flange structure 22 according to claim 8 wherein two diametrically opposite slits 221 are provided.

12. A flange structure 22 according to any of claims 8 to 11 wherein the flange 22 has a square collar 222 formed at the other end 22b.

13. A flange structure 22 according to claim 12 wherein the square collar 222 has four flat side surfaces 223, which can be selectively used as bearing a setting mark.

14. A flange structure 22 according to claim 12 wherein the square collar 222 has its opening end 22b chamfered inside.
